(19) United States
(12) Patent Application Publication
(10) Pub. No.: US 2007/0135096 A1
(43) Pub. Date: Jun. 14, 2007

(54) Interactive voice browsing server for mobile devices on wireless networks

(75) Inventor: Hari Prasad Sampath, Bangalore (IN)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/300,777

(22) Filed: Dec. 14, 2005

(51) Int. Cl. H04L 12/58

(52) U.S. Cl. 455/412.1

(57) ABSTRACT

The wireless data communication system described herein generally includes a wireless mobile computing device, a WLAN infrastructure, a server, and a database. The mobile computing device includes voice interface functionality that enables the device to receive voice signals and generate voice commands for wireless transmission to the WLAN infrastructure. The server includes a voice command interpreter that processes received voice commands to identify the data requested by the user of the wireless mobile computing device. Once the requested data is identified, the server obtains the requested data from the database and generates a reply for the wireless mobile computing device. The reply is formatted such that it initiates a response at the wireless mobile computing device, where the response conveys at least a portion of the requested data.

### TECHNICAL FIELD OF THE INVENTION

The present invention relates generally to data communication. More particularly, the present invention relates to a voice browsing feature for accessing remotely stored data by a wireless handheld computing device.

### BACKGROUND OF THE INVENTION

The prior art is replete with different types of handheld mobile computing devices. Handheld mobile computing devices include personal digital assistants (“PDAs”), feature-rich cellular telephones, palmtop computers, rugged mobile computers designed for industrial use, and the like. Many handheld mobile computing devices also function as wireless communication devices. These wireless handheld computing devices are designed to communicate with another computing device via a wireless communication link. For example, some wireless handheld computing devices can communicate with a wireless local area network (“WLAN”) architecture using standardized wireless data communication protocols. Some wireless handheld computing devices are capable of retrieving data stored in a remote database once a suitable communication link has been established between the database and the wireless handheld computing device.

Traditional handheld computing devices obtain user input data from keypad entries, stylus touch screens, or other user interface devices that require manual manipulation by the user. Manual input can be difficult or inconvenient in some practical situations, for example, in a hospital environment where caregivers must use their hands to examine or treat patients. In this example, it can be cumbersome or impossible for a caregiver to simultaneously examine a patient and manipulate the user interface of a handheld computing device, where the handheld computing device is used to access patient data, hospital data, research materials, or the like.

Accordingly, it is desirable to have a technique for the retrieval of remotely stored data for presentation at a wireless handheld computing device. In addition, it is desirable to have a wireless handheld computing device (and supporting network architecture) that is capable of responding to voice prompts from the user to enable hands free retrieval and presentation of remotely stored data. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

A wireless handheld computing device and related operating methods are described herein. The wireless handheld computing device includes an integrated voice interface that is designed to recognize certain voice prompts representing requests for data stored in a remote database. The wireless handheld computing device supports hands free operation such that a user can request and obtain data without physically manipulating the device.

A server system that supports the wireless handheld computing device (and related operating methods for the server system) are also described herein. The server system includes an integrated voice command interpreter that processes a voice command received from the wireless handheld computing device. The server system can communicate with a database to retrieve the requested data, and transmit the requested data in an appropriate format for presentation at the wireless handheld computing device.

The above and other aspects of the invention may be carried out in one form by a method for retrieving data for wireless handheld computing devices. The method involves: acquiring an audio signal at a wireless handheld computing device; transmitting a voice command in accordance with a wireless data communication protocol, the voice command corresponding to the audio signal, and the voice command representing a data request; obtaining data from a remote database, the data corresponding to the data request; and transmitting, to the wireless handheld computing device, a reply to the voice command. The reply initiates a response by the wireless handheld computing device, and the response conveys at least a portion of the data.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of a data communication system according to an example embodiment of the invention;

FIG. 2 is a schematic representation of a wireless handheld computing device configured in accordance with an example embodiment of the invention;

FIG. 3 is a schematic representation of a server system configured in accordance with an example embodiment of the invention;

FIG. 4 is a timing diagram that represents the retrieval of remote data by a wireless handheld computing device;

FIG. 5 is a flow chart of a portion of a data retrieval process, as performed by a wireless handheld computing device; and

FIG. 6 is a flow chart of a portion of a data retrieval process, as performed by a server system.

### DETAILED DESCRIPTION OF THE INVENTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to computer device platforms, wireless data transmission, signaling, WLANs, network control, database management, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

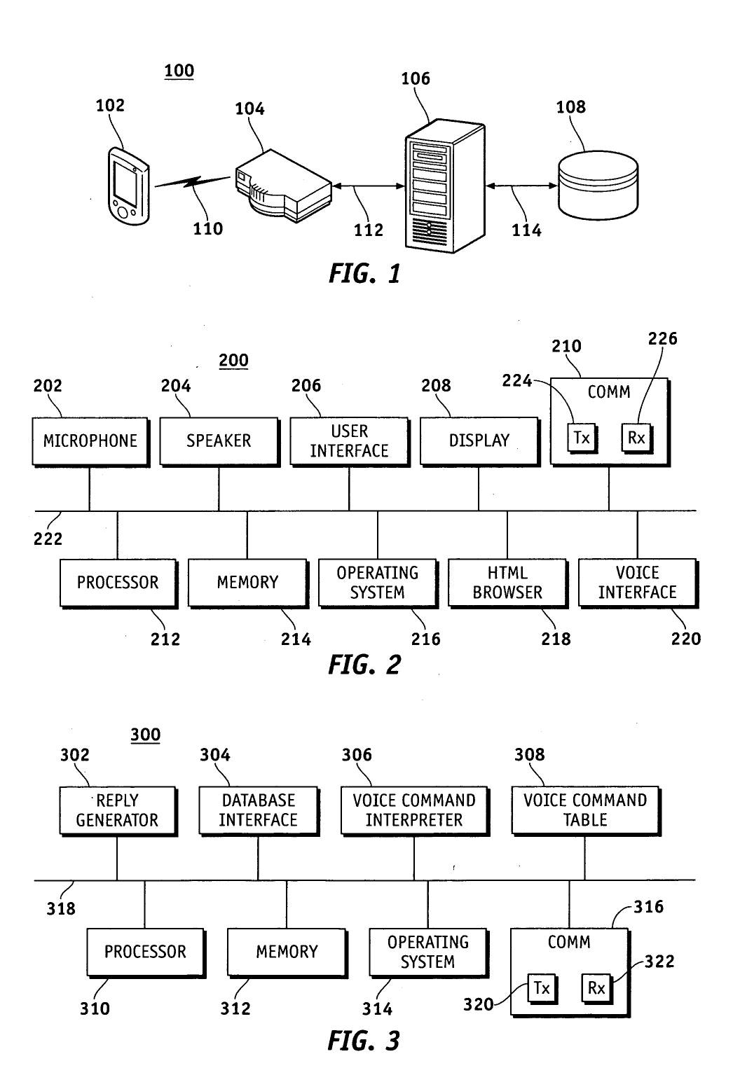

The following description may refer to elements or features being “connected” or “coupled” together. As used herein, unless expressly stated otherwise, “connected” means that one element/feature is directly joined to (or directly communicates with) another element/feature, and not necessarily mechanically. Likewise, unless expressly stated otherwise, “coupled” means that one element/feature is directly or indirectly joined to (or directly or indirectly communicates with) another element/feature, and not necessarily mechanically. Thus, although the schematics shown in FIGS. 1-3 depict example arrangements of elements, additional intervening elements, devices, features, or components may be present in an actual embodiment (assuming that the functionality of the system or components is not adversely affected).

The techniques described herein can be deployed in various practical environments where hands free operation of a wireless mobile computing device might be advantageous. To illustrate the operation of an example system, consider a hospital environment where a caregiver has access to a wireless mobile computing device as described herein. The caregiver may need to access patient data while concurrently tending to the patient, e.g., conducting a physical examination, performing a medical procedure, or the like. If the caregiver needs to access remotely stored patient data, he vocalizes a predefined voice prompt to the mobile device, where the voice prompt represents a request for certain data stored at the enterprise database maintained by the hospital. A voice interface integrated into the mobile device captures the audio signal and represents the voice prompt as a suitably formatted voice command. The formatted voice command is then transmitted over a wireless link to a WLAN architecture, which can then route the voice command to a server system coupled to the hospital database.

In this example deployment, the server system includes a voice command interpreter that processes the voice command such that the requested data can be fetched from the hospital database using the existing interface to the enterprise backend infrastructure. Once the server system obtains the requested data, it generates an appropriate reply for the mobile computing device. The reply initiates the presentation of the requested data at the mobile computing device. For example, the requested data may be presented in a graphical format, a text format, as an audio clip, as a video clip, or the like. The voice browsing capability of the mobile computing device makes it easy for the caregiver to access and review patient data without having to physically manipulate the device.

FIG. 1 is a schematic representation of a data communication system 100 according to an example embodiment of the invention. The voice browsing techniques described in more detail below can be implemented in data communication system 100 (and other practical architectures). Data communication system 100 generally includes a wireless mobile computing device 102, a WLAN infrastructure 104, a remote server 106, and a database 108. In operation, wireless mobile computing device 102 is coupled to WLAN infrastructure 104, which is coupled to remote server 106, which is coupled to database 108.

Wireless mobile computing device 102 may leverage known aspects of existing general computing platforms capable of supporting wireless data communication, including, without limitation: PDAs; cell phones; portable computers such as laptops, palmtops, and tablet PCs; or general purpose mobile computing devices. For the sake of brevity, conventional aspects of wireless mobile computing device 102 will not be addressed herein. Notably, wireless mobile computing device 102 supports wireless data communication with WLAN infrastructure 104 via a wireless link 110. Such wireless data communication, characteristics of wireless link 110, and the manner in which wireless link 110 is created and maintained may be governed by one or more applicable wireless data communication protocols and/or one or more applicable network protocols. In the example embodiment, wireless mobile computing device 102 is configured to support WLAN connectivity in compliance with established IEEE Standards, such as 802.11a, 802.11b, and 802.11b/g. Of course, wireless mobile computing device 102 may be configured to support alternate or additional wireless data communication protocols, including future variations of 802.11 such as 802.11n. Device 102 may also utilize other technologies such as Bluetooth; GPRS; wireless USB; IEEE 802.15.4 (ZigBee); IEEE 802.16 (WiMAX); or IrDA (infrared).

WLAN infrastructure 104 is generally configured to function as an intermediary between the wireless domain and the traditional wired LAN domain. For example, WLAN infrastructure 104 can receive data via wireless link 110, and forward the received data to remote server 106 via a physical link 112. In the reverse direction, WLAN infrastructure 104 can receive data from remote server 106 on physical link 112, and send the received data to wireless mobile computing device 102 over wireless link 110. The data communication between WLAN infrastructure 104 and remote server 106, characteristics of physical link 112, and the manner in which a data communication channel is established and maintained over physical link 112 may be governed by one or more applicable data communication protocols and/or one or more applicable network protocols. In the example embodiment, WLAN infrastructure 104 provides an Ethernet interface for remote server 106 such that WLAN infrastructure 104 can communicate with a conventional Ethernet-based computer network. In this regard, physical link 112 may include traditional LAN data cabling, connectors, switches, and/or other conventional components, WLAN infrastructure 104 may include a physical interface for connection to the computer network, and WLAN infrastructure 104 may handle Ethernet addressing for data packets.

In practical embodiments, WLAN infrastructure 104 may include one or more components that cooperate with each other to provide the desired functionality. For example, WLAN infrastructure 104 may include, without limitation: wireless access points; wireless access ports; wireless switches; wireless routers; bridges; adapters; voice gateways for Voice Over WLAN support (“VoWLAN”); analog/digital telephone PBX; or the like. The design and operation of such components are known to those skilled in the art and, therefore, conventional aspects of WLAN infrastructure 104 will not be described in detail herein.

Remote server 106 is “remote” in that it need not be physically located near to wireless mobile computing device 102. In the hospital setting described above, for example, remote server 106 may be located in a computer equipment room in the basement of the hospital building, while wireless mobile computing device 102 can roam to any patient room, treatment area, operating room, etc. For purposes of the example system described herein, remote server 106 is generally configured to function as an intermediary between WLAN infrastructure 104 and database 108. In this regard, remote server 106 can receive data representing a voice command via physical link 112, process the voice command, and communicate with database 108 via a physical link 114 to retrieve requested data stored in database 108. In the reverse direction, remote server 106 can receive data from database 108 on physical link 114, and send the received data (in a suitable format) to WLAN infrastructure 104 over physical link 112. The data communication between remote server 106 and database 108, characteristics of physical link 114, and the manner in which a data communication channel is established and maintained over physical link 114 may be governed by one or more applicable data communication protocols, one or more database management protocols, and/or one or more applicable network protocols. In the example embodiment, remote server 106 communicates with database 108 in accordance with conventional Ethernet-based computer network techniques. In this regard, physical link 114 may include traditional LAN data cabling, connectors, switches, and/or other conventional components, remote server 106 may include a physical interface for connection to the computer network, and remote server 106 may handle Ethernet addressing for data packets.

In practical embodiments, remote server 106 may include one or more features or components that cooperate with each other to provide the desired functionality. Moreover, remote server 106 may be suitably configured to support any number of features or functions that are unrelated to the voice browsing methodologies described herein. For example, remote server 106 may be configured to provide a platform for supporting and managing mobile devices in the system, i.e., remote server 106 may provide enhanced functionality that cooperates with certain mobile applications supported by wireless mobile computing devices. Such enhanced functionality may be desirable in an enterprise-wide deployment where remote server 106 supports a large number of mobile devices, e.g., inventory control systems, RFID systems, or the like.

In practice, database 108 may leverage well known data storage, database management, and other database-related technologies. In the preferred embodiment, database 108 has a conventional configuration, and the manner in which data is accessed and retrieved from database 108 comports with conventional protocols. Accordingly, remote server 106 need not utilize customized or proprietary communication protocols to obtain data from database 108, and remote server 106 may be configured to format compatible database queries for database 108 in response to voice commands received from wireless mobile computing device 102.

FIG. 2 is a schematic representation of a wireless mobile computing device 200 configured in accordance with an example embodiment of the invention. Device 200 is suitable for use in data communication system 100 (see FIG. 1). Device 200 generally includes at least one microphone 202, at least one speaker 204, a user interface 206, a display element 208, a communication element 210, a processor architecture 212, memory 214, an operating system 216, an HTML browser 218, and a voice interface 220. Device 200 may include a suitable interconnect architecture 222 that couples the various elements together. Interconnect architecture 222 allows the various elements to communicate with each other as needed, to transfer data as needed, and the like. In a practical embodiment, device 200 will include additional features, components, and functions that are unrelated to the voice browsing techniques described herein.

Microphone 202 represents one practical implementation of an input port for wireless mobile computing device 200. Microphone 202 is designed to acquire an audio signal using well known transducer technology. In practice, the audio signal can be a voice signal that is acquired by device 200 in real-time. This enables device 200 to immediately respond to user voice prompts, retrieve data from a remote database, and present the requested data to the user in an appropriate format without having to rely on physical manipulation of device 200. Accordingly, microphone 202 may be coupled to voice interface 220 via interconnect architecture 222.

Speaker 204, which may be coupled to voice interface 220 via interconnect architecture 222, represents one practical implementation of an output element for wireless mobile computing device 200. Speaker 204 generates audio signals using well known transducer technology. In this example, speaker 204 generates an audio reply signal that conveys requested data or information (or a portion thereof) to the user in response to a voice prompt received by device 200. Moreover, speaker 204 can be utilized to reproduce sound associated with audio files that have been formatted for playback at device 200. Thus, device 200 may also include a sound card (or equivalent functionality) that enables it to process and audio in an appropriate manner. Such functionality may be necessary to support playback of audio files at device 200, where such audio files convey requested data or information (or a portion thereof) to the user in response to a voice prompt received at device 200.

User interface 206 may include any number of elements that enable the user to interact with wireless mobile computing device 200. For example, user interface 206 may include one or more of the following elements, without limitation: a keypad; a touchpad; a stylus pad; switches; buttons; a pointing device such as a trackball, mouse, or joystick; or lighting elements. Although depicted as a separate block in FIG. 2, display element 208 may be considered to be a part of user interface 206. Display element 208, which may be coupled to voice interface 220 via interconnect architecture 222, represents one practical implementation of an input/output element for device 200. In the example embodiment described herein, voice interface 220 is suitably configured to initiate the rendering of graphics on display element 208, where such graphics convey requested data or information (or a portion thereof) to the user in response to a voice prompt received by device 200. In this regard, device 200 may include a suitably configured graphics card (or equivalent functionality) that enables it to format and render graphics on display element 208. Moreover, display element 208 is preferably configured to render video images associated with video files that have been formatted for playback at device 200. Thus, device 200 may also include a video card (or equivalent functionality) that enables it to format and render video on display element 208. Such functionality may be necessary to support playback of video files at device 200, where such video files convey requested data or information (or a portion thereof) to the user in response to a voice prompt received at device 200.

Communication element 210 generally refers to features and components that enable wireless mobile computing device 200 to communicate with another device, such as a remote computing device, a network component, or the like. Although this description focuses on wireless communication by device 200, communication element 210 may also support data communication over a physical connection. In this example, communication element 210 supports wireless data communication between WLAN infrastructure 104 (see FIG. 1) in accordance at least one wireless data communication protocol, such as IEEE 802.11 (any variation thereof). To support bi-directional wireless communication with WLAN infrastructure 104, communication element 210 may include a suitably configured transmitter 224 and a suitably configured receiver 226. In practice, transmitter 224 and receiver 226 may form a combined transceiver module for device 200. In operation, communication element 210 transmits voice commands from device 200, and receives replies to the respective voice commands (described in more detail below).

Processor architecture 212 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. As depicted in FIG. 2, processor architecture 212 may be in communication with the various components and functional elements of wireless mobile computing device 200. In practice, processor architecture 212 represents processing logic that is configured to carry out the techniques and processing tasks described in more detail below.

Memory 214 may be implemented or realized with RAM memory, flash memory, ROM memory, EPROM memory, EEPROM memory, registers, a hard disk, a removable disk, a CD-ROM, or any other form of storage medium known in the art. In this regard, memory 214 can be coupled to processor architecture 212 such that processor architecture 212 can read information from, and write information to, memory 214. In the alternative, memory 214 may be integral to processor architecture 212. As an example, processor architecture 212 and memory 214 may reside in a suitably configured ASIC. Memory 214 includes sufficient data storage capacity to support the operation of wireless mobile computing device 200.

Operating system 216 is associated with the general computing platform employed by wireless mobile computing device 200. As in most commercially available general purpose computing devices, a practical computing architecture that supports device 200 may be configured to run on any suitable operating system such as Windows CE, the Palm OS, the Windows Pocket PC OS, Symbian OS, Linux OS, or the like. The specific functionality of operating system 216 and the manner in which it governs the general operation of device 200 will not be described herein; such details are known to those skilled in the art.

HTML browser 218 may be a conventional application that is used to locate and display HTML documents, such as web pages, from remote sources. HTML browser 218 may leverage known technologies that enable wireless mobile computing device 200 to present multimedia information to the user. Voice interface 220, which may be integrated with HTML browser 218, is configured to process voice prompts received by device 200. Voice interface 220 may incorporate technologies which exist or incorporate an entirely new module developed as per the functional requirements. Alternatively, voice interface 220 may utilize any practical technology, such as VoiceXML, or SALT (or a portion thereof) coupled with a newly developed software module.

Voice interface 220 may be coupled to microphone 202 to allow voice interface 220 to convert the input audio signal into a voice command that is formatted in compliance with the wireless data communication protocol(s) utilized by device 200. As explained below, the voice command represents a request for application data stored at database 108 (see FIG. 1). Voice interface 220 generally seeks to retrieve data for presentation at device 200 in response to a real-time voice signal that represents a request for that data. In practical embodiments, transmitter 224 can be coupled to voice interface 220 to facilitate transmission of voice commands generated by voice interface 220.

In operation, voice interface 220 generally functions to receive speech or voice from the user, to process the voice signal, and to represent the voice signal in an appropriate internal format. Voice interface 220 is preferably coupled to communication element 210 to facilitate communication with other components in the network. For example, after the requested data is received at device 200, voice interface 220 can fetch that data, analyze the manifestation of the data (the data format mentioned in this context is known to the server, and the server can tag the reply with appropriate information that can be interpreted by voice interface 220. Voice interface 220 can then analyze the tags and invoke existing components on device 200, which are used to display or present the data in an appropriate manner. For example, if requested data is maintained in the remote database as an HTML file, then voice interface 220 may invoke a web browser application to display that HTML file to the user. As another example, if requested data is maintained in the remote database as an EXCEL file, then voice interface 220 may invoke the MICROSOFT EXCEL program to display that file to the user.

FIG. 3 is a schematic representation of a server 300 configured in accordance with an example embodiment of the invention. Server 300 is suitable for use in data communication system 100 (see FIG. 1). Server 300 generally includes a reply generator 302, a database interface 304, a voice command interpreter 306, a voice prompt table 308, a processor architecture 310, memory 312, an operating system 314, and a communication element 316. Server 300 may include a suitable interconnect architecture 318 that couples the various elements together. Interconnect architecture 318 allows the various elements to communicate with each other as needed, to transfer data as needed, and the like. In a practical embodiment, server 300 will include additional features, components, and functions that are unrelated to the voice browsing techniques described herein.

Reply generator 302, which may be realized as processing logic, generates a reply in response to a voice command that originates from the wireless mobile computing device, and server 300 transmits the reply to the originating wireless mobile computing device. In operation, the reply is configured to initiate a response by the wireless mobile computing device, such that the response conveys the requested data (or a portion thereof). Thus, the reply may include: a markup language file that conveys at least a portion of the requested data; an audio file formatted for playback at the remote wireless mobile computing device; a video file formatted for playback at the remote wireless mobile computing device; an applet formatted for execution at the remote wireless mobile computing device, where execution of the applet by the mobile device conveys at least a portion of the requested data; a graphics or text file formatted for rendering at the remote wireless mobile computing device; or the like. The operation of reply generator 302, and the characteristics of the reply, may depend upon various factors, including, but not limited to: the characteristics of the requested data; the manner in which the requested data is to be presented; the output capabilities of the wireless mobile computing device; the types of files supported by the wireless mobile computing device; and the like. Practical implementations may be suitably configured to handle WAV files, MPEG files, JPEG files, MOV files, GIF files, etc. In one example embodiment, reply generator 302 is configured to understand the format(s) in which the native data is stored in the enterprise database. Reply generator 302 can then formulate a reply that contains the requested native data along with additional information (e.g., a tag, identifier, or the like) associated with the data format. As mentioned above in connection with the voice interface, the mobile computing device may be suitably configured to interpret the nature of the received data and invoke the appropriate data manifestation tool for presentation of the data (e.g., a web browser, a media player, a software application, or the like).

Database interface 304 represents hardware, software, and/or processing logic that enables server 300 to communicate with a database using the native language, database management protocols, and nomenclature of the database. For example, database interface 304 is suitably configured to create a database query for a data request, where the database query is formatted for compliance with the database, and to make the database query available for transmission to the database. Moreover, database interface 304 obtains the requested data (or a portion thereof) from the database so that server 300 can process the requested data in an appropriate manner.

Voice command interpreter 306 is configured to process voice commands that originate from the wireless mobile computing device. Briefly, voice command interpreter 306 processes voice commands to identify data requests corresponding to the respective voice commands. In practice, voice command interpreter 306 compares a received voice command to a plurality of predefined or standardized voice prompts, which may be maintained in voice prompt table 308. Voice command interpreter 306 processes the received voice command to find a matching entry in voice prompt table 308. Such processing allows server 300 to identify the data being requested by the voice command, which then enables server 300 to format the database query in an appropriate manner.

Processor architecture 310 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. As depicted in FIG. 3, processor architecture 310 may be in communication with the various components and functional elements of server 300. In practice, processor architecture 310 represents processing logic that is configured to carry out the techniques and processing tasks described in more detail below.

Memory 312 may be implemented or realized with RAM memory, flash memory, ROM memory, EPROM memory, EEPROM memory, registers, a hard disk, a removable disk, a CD-ROM, or any other form of storage medium known in the art. In this regard, memory 312 can be coupled to processor architecture 310 such that processor architecture 310 can read information from, and write information to, memory 312. In the alternative, memory 312 may be integral to processor architecture 310. As an example, processor architecture 310 and memory 312 may reside in a suitably configured ASIC. Memory 312 includes sufficient data storage capacity to support the operation of server 300.

Operating system 314 is associated with the general computing platform employed by server 300. As in most commercially available general purpose computing devices, a practical computing architecture that supports server 300 may be configured to run on any suitable operating system such as Unix, Linux, the Apple Macintosh OS, Solaris OS, any variant of Microsoft Windows, a commercially available real time operating system, or a customized operating system. The specific functionality of operating system 314 and the manner in which it governs the general operation of server 300 will not be described herein; such details are known to those skilled in the art.

Communication element 316 generally refers to features and components that enable server 300 to communicate with another device, such as a remote computing device, a network component, a WLAN infrastructure, or the like. In preferred practical embodiments, communication element 316 supports data communication over a physical connection. In this example, communication element 316 supports data communication between WLAN infrastructure 104 (see FIG. 1) in accordance with Ethernet-based protocols. To support bi-directional communication with WLAN infrastructure 104, communication element 316 may include a suitably configured output element or transmitter 320 and a suitably configured input element or receiver 322. In practice, transmitter 320 and receiver 322 may form a combined transceiver module for device 200. In operation, communication element 316 receives voice commands that originate from remote mobile devices, and transmits replies to voice commands back to the respective originating mobile devices (described in more detail below).

Those of skill in the art will understand that the various illustrative blocks, modules, circuits, and processing logic described in connection with the embodiments disclosed herein may be implemented in hardware, computer software, firmware, or any practical combination thereof. To clearly illustrate this interchangeability and compatibility of hardware, firmware, and software, various illustrative components, blocks, modules, circuits, and steps have been described above generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the invention.

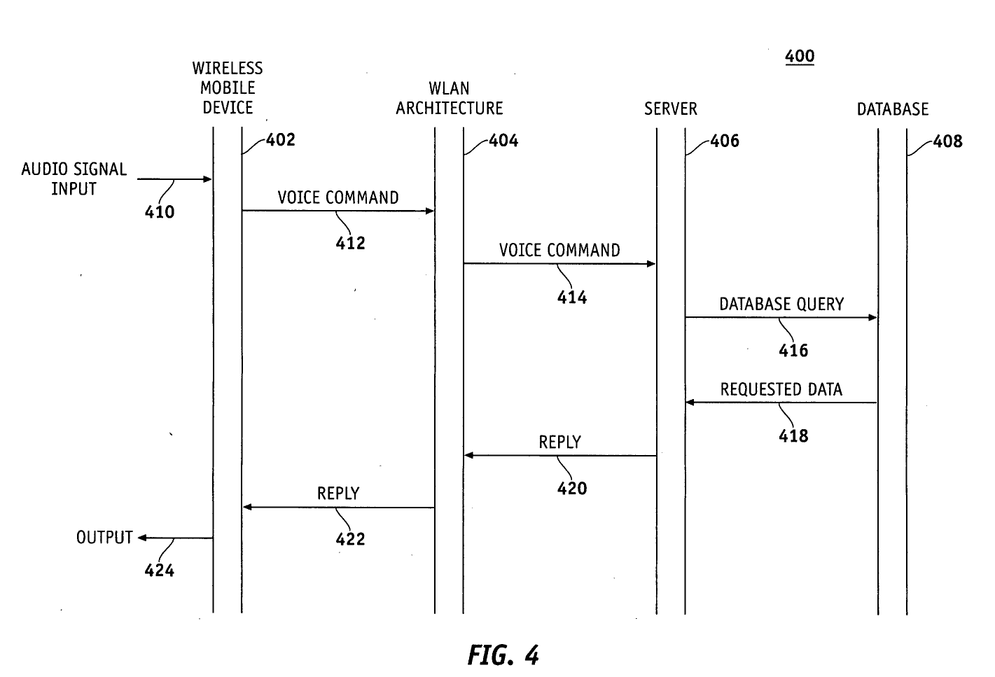

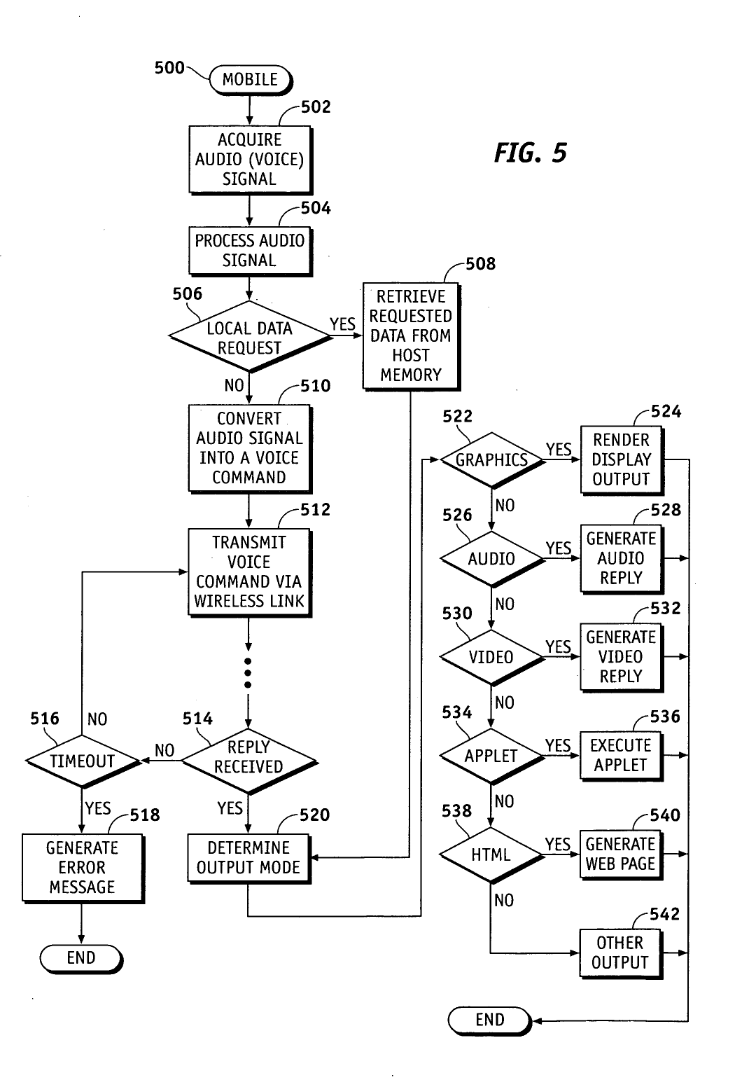

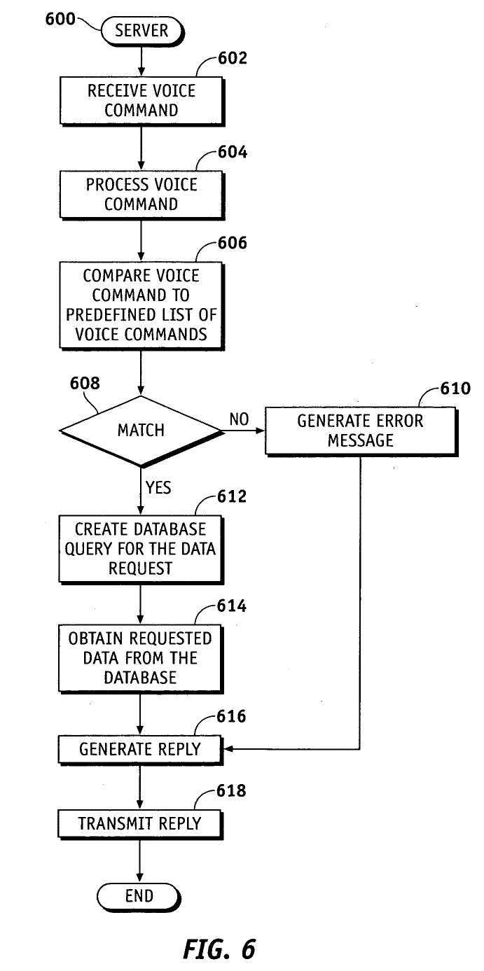

A typical voice browsing operation using a wireless mobile computing device will now be described with reference to FIGS. 4-6. FIG. 4 is a timing diagram 400 that represents the retrieval of remote data by a wireless handheld computing device, FIG. 5 is a flow chart of the portion of the data retrieval process performed by the wireless mobile computing device, and FIG. 6 is a flow chart of the portion of the data retrieval process performed by the server. For convenience, the tasks depicted in FIG. 5 are identified as a mobile process 500, while the tasks depicted in FIG. 6 are identified as a server process 600. The vertical bars in FIG. 4 represent the following components of a data communication system: a wireless mobile device 402; a WLAN architecture 404; a server 406; and a database 408. In FIG. 4, events occur in time from the top of timing diagram 400 to the bottom of timing diagram 400.

The steps of a method or algorithm described in connection with the embodiments disclosed herein may be embodied directly in hardware, in firmware, in a software module executed by a processor, or in any practical combination thereof. A software module may reside in RAM memory, flash memory, ROM memory, EPROM memory, EEPROM memory, registers, a hard disk, a removable disk, a CD-ROM, or any other form of storage medium known in the art. In this regard, an exemplary storage medium can be coupled to a processor such that the processor can read information from, and write information to, the storage medium. In the alternative, the storage medium may be integral to the processor, as mentioned previously.

For illustrative purposes, the following description of mobile process 500 and server process 600 may refer to elements mentioned above in connection with FIGS. 1-3. In practical embodiments, portions of these processes may be performed by different elements of the described system, e.g., the wireless device or the server. It should be appreciated that either or both of these processes may include any number of additional or alternative tasks, the tasks shown in the figures need not be performed in the illustrated order, and the processes may be incorporated into a more comprehensive procedure or process having additional functionality not described in detail herein.

Assuming that the wireless mobile device is in an active voice browsing mode, the data retrieval process begins with wireless mobile computing device 402 acquiring an audio (voice) signal as an input (task 502). The timing diagram 400 identifies the audio signal input with an arrow 410. The voice signal should be from a set of predefined voice prompts that can be recognized and processed by the mobile device. For example, the audio signal may be a spoken word, phrase, or recognizable sound, such as: “patient data,” “medical history,” “x-rays,” “medications,” or the like. Wireless mobile computing device 402 processes the received audio signal (task 504) in a suitable manner to determine how best to proceed.

Wireless mobile computing device 402 may be capable of accessing locally stored data in addition to remotely stored data. Assuming this is the case, mobile process 500 may perform a query task 506 to determine whether the received voice signal represents a local data request. If so, then wireless mobile device 402 can retrieve the requested data directly from its host memory (task 508) and process the retrieved data as described in more detail below in connection with task 520. If the received voice signal does not represent a local data request, then mobile process 500 may convert the received audio signal into a suitably configured voice command (task 510). Device 402 may leverage known voice recognition techniques to perform local data retrieval procedures. As mentioned above, the voice command is preferably formatted in compliance with at least one wireless data communication protocol utilized by the data communication system. For example, the voice command may be formatted in accordance with a variant of IEEE Standard 802.11. The voice command may be realized as one or more data packets, and the voice command represents a request for data stored on the remote database. In this example, the voice interface of wireless mobile device 402 processes the input voice signal and converts the voice signal into the voice command.

Eventually, wireless mobile device 402 transmits the voice command via a wireless link (task 512). The wireless transmission is performed in accordance with the particular wireless data communication protocol. Timing diagram 400 depicts the wireless transmission of the voice command with an arrow 412. In this example, the voice command is initially transmitted from wireless mobile device 402 to WLAN architecture 404. Thereafter, the voice command (or equivalent data) is transmitted from WLAN architecture 404 to server 406. Timing diagram 400 depicts this transmission of the voice command with an arrow 414. WLAN architecture 404 may simply forward the voice command to server 406. Alternatively, WLAN architecture 404 may modify the voice command, reformat the voice command, or convert the voice command into another format before sending it to server 406. Referring again to task 512, once the wireless mobile device transmits the voice command, mobile process 500 waits for a reply to the voice command. The ellipses in FIG. 5 represent this brief waiting period.

Referring now to FIG. 6, server process 600 may begin when server 406 receives the voice command (task 602). Timing diagram 400 depicts the receiving of the voice command with arrow 414. Server 406 processes the received voice command (task 604) in a suitable manner to identify the data request associated with that voice command. In one practical embodiment, the voice command interpreter of server 406 compares the received voice command to a plurality of predefined voice prompts (task 606). As mentioned above, the predefined voice prompts may be maintained in a voice prompt table or an equivalent memory structure. If server 406 does not identify a matched voice prompt from the plurality of predefined voice prompts (query task 608), then server 406 may generate an error message (task 610) or otherwise process the error condition in an appropriate manner. If, however, server 406 matches the received voice command to one of the predefined voice prompts, then server 406 can create a suitably formatted database query (task 612) corresponding to the data request conveyed by the received voice command. As described above, the database query is preferably formatted for compliance with the particular database architecture (database 408 in FIG. 4) that contains the requested data. Timing diagram 400 depicts the database query with an arrow 416. The database query enables server 406 to retrieve the requested data from database 408.

In response to the database query, server 406 obtains the requested data from database 408 (task 614). Timing diagram 400 depicts the provision of the requested data with an arrow 418. In the example embodiment, server 406 generates an appropriate reply to the received voice command (task 616). The actual contents of the reply, the format of the reply, the configuration of the reply, and other characteristics of the reply may vary depending upon a number of factors, as described above in connection with reply generator 302 (see FIG. 3). Generally, the reply is intended to initiate an appropriate response by wireless mobile device 402, where that response conveys at least a portion of the requested data (see above description). Again, the reply may represent or include a video file, an audio file, a graphics file, a text file, an applet, a markup language file, a web page, or the like. Note that the reply may alternatively include the error message generated in task 610. Eventually, server 406 transmits the reply, with the originating wireless mobile device 402 as the destination (task 618). Timing diagram 400 depicts the transmission of the reply from server 406 to WLAN architecture 404 with an arrow 420. In this example, the reply is initially transmitted from server 406 to WLAN architecture 404. Thereafter, the reply (or equivalent data) is transmitted from WLAN architecture 404 to wireless mobile device 402. Timing diagram 400 depicts this transmission of the reply with an arrow 422. WLAN architecture 404 may simply forward the reply to wireless mobile device, or it may modify the reply, reformat the reply, or convert the reply into another format before sending it to wireless mobile device 402. In practice, WLAN architecture 404 transmits the reply in accordance with the particular wireless data communication protocol corresponding to the link between WLAN architecture 404 and wireless mobile device 402.

Referring back to FIG. 5, wireless mobile device 402 waits to receive a reply to the transmitted voice command (query task 514). If no reply is received within a specified timeout period (query task 516), then mobile process 500 may generate an error message an error message (task 518) or otherwise process the error condition in an appropriate manner. If the timeout period has not elapsed, then mobile process 500 may be re-entered at task 512 to retransmit the voice command. Alternatively, mobile process 500 may simply continue to wait for a reply during the entire timeout period without retransmitting the voice command.

In the example embodiment, wireless mobile device 402 receives the reply in accordance with the wireless data communication protocol utilized by WLAN architecture 404. Wireless mobile device 402 may process the received reply in an appropriate manner to determine its contents, to determine an output mode (task 520), or to otherwise determine how best to handle the reply. Ultimately, wireless mobile device 402 generates an output that conveys the requested data, or a portion thereof. Timing diagram 400 depicts the presentation of the output with an arrow 424. As mentioned above, the type of output may vary depending upon the voice command, the requested data format, the operating characteristics of wireless mobile device 402, and other operating conditions.

As an example, if the reply includes a graphics file or otherwise initiates the generation of graphics at wireless mobile device 402 (query task 522), then wireless mobile device 402 can render a corresponding display output that conveys the requested data, or a portion thereof (task 524). If the reply includes an audio file or otherwise initiates the generation of audio at wireless mobile device 402 (query task 526), then wireless mobile device 402 can generate a corresponding audio reply signal that conveys the requested data, or a portion thereof (task 528). If the reply includes a video file or otherwise initiates the generation of video at wireless mobile device 402 (query task 530), then wireless mobile device 402 can generate a corresponding video presentation that conveys the requested data, or a portion thereof (task 532). If the reply includes an applet (query task 534), then wireless mobile device 402 can extract and execute the applet to convey the requested data, or a portion thereof, in a manner dictated by the applet (task 536). If the reply includes an HTML file (query task 538), then wireless mobile device 402 can extract and process the HTML file to generate a corresponding web page that conveys the requested data, or a portion thereof (task 540). Of course, the methodology described herein is not limited to these particular output formats, and wireless mobile device 402 may be configured to generate other outputs (task 542) not specifically mentioned herein. In preferred embodiments, the output mode need not require physical manipulation of wireless mobile device 402 by the operator.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for retrieving data for wireless mobile computing devices, said method comprising:
receiving a voice command that originates from a remote wireless mobile computing device, said voice command representing a data request;
processing said voice command to identify said data request;
obtaining data from a database, said data corresponding to said data request; and
transmitting, to said remote wireless mobile computing device, a reply to said voice command, said reply being configured to initiate a response by said remote wireless mobile computing device, said response conveying at least a portion of said data.

2. A method according to claim 1, said reply comprising a markup language file that conveys said at least a portion of said data.

3. A method according to claim 1, said reply comprising an audio file formatted for playback at said remote wireless mobile computing device, said audio file conveying said at least a portion of said data.

4. A method according to claim 1, said reply comprising a video file formatted for playback at said remote wireless mobile computing device, said video file conveying said at least a portion of said data.

5. A method according to claim 1, said reply comprising an applet formatted for execution at said remote wireless mobile computing device, wherein execution of said applet conveys said at least a portion of said data.

6. A method according to claim 1, wherein processing said voice command comprises matching said voice command to one of a plurality of predefined voice prompts.

7. A method according to claim 1, further comprising creating a database query for said data request, said database query being formatted for compliance with said database.

8. A system for retrieving data for wireless mobile computing devices, said system comprising:
an input element configured to receive a voice command that originates from a remote wireless mobile computing device, said voice command representing a data request;
a voice command interpreter coupled to said input element, said voice command interpreter being configured to process said voice command to identify said data request;
a database interface coupled to said voice command interpreter, said database interface being configured to obtain data from a database, said data corresponding to said data request; and
an output element configured to transmit, to said remote wireless mobile computing device, a reply to said voice command, said reply being configured to initiate a response by said remote wireless mobile computing device, said response conveying at least a portion of said data.

9. A system according to claim 8, said reply comprising a markup language file that conveys said at least a portion of said data.

10. A system according to claim 8, said reply comprising an audio file formatted for playback at said remote wireless mobile computing device, said audio file conveying said at least a portion of said data.

11. A system according to claim 8, said reply comprising a video file formatted for playback at said remote wireless mobile computing device, said video file conveying said at least a portion of said data.

12. A system according to claim 8, said reply comprising an applet formatted for execution at said remote wireless mobile computing device, wherein execution of said applet conveys said at least a portion of said data.

13. A system according to claim 8, said voice command interpreter being configured to match said voice command to one of a plurality of predefined voice prompts.

14. A system according to claim 8, said database interface being configured to create a database query for said data request, said database query being formatted for compliance with said database.
